(19) United States
(12) Patent Application Publication
(10) Pub. No.: US 2013/0218408 A1
(43) Pub. Date: Aug. 22, 2013

(54) METHOD AND APPARATUS FOR IMPROVING VEHICLE FUEL ECONOMY WITH ENERGY STORAGE EFFICIENCY MODEL

(71) Applicants: Songping Yu, Troy, MI (US); Peter G. Hartman, West Bloomfield, MI (US); Michael J. Prucka, Ann Arbor, MI (US)

(72) Inventors: Songping Yu, Troy, MI (US); Peter G. Hartman, West Bloomfield, MI (US); Michael J. Prucka, Ann Arbor, MI (US)

(73) Assignee: CHRYSLER GROUP LLC, Auburn Hills, MI (US)

(21) Appl. No.: 13/399,374

(22) Filed: Feb. 17, 2012

(51) Int. Cl. G06F 7/00; G05F 5/00

(52) U.S. Cl. 701/36; 700/286

(57) ABSTRACT

A method is described for improving fuel economy in a vehicle having an engine, a generator driven by the engine, and an energy storage unit by using an energy storage efficiency model. The method includes evaluating a current efficiency state of the engine, evaluating a current efficiency state of the generator, evaluating a current efficiency state of the energy storage unit, and, controlling the generator to provide an optimized voltage output, based on the results of the evaluations and the energy storage efficiency model. A voltage regulator implementing this method is also described.

### FIELD

The present disclosure relates to improving fuel economy by optimizing electrical energy generation and consumption.

### BACKGROUND

Presently, fuel economy benefits related to the control of electrical energy generation and consumption are limited to discretized methods that rely on particular operating conditions of a vehicle, such as load level, deceleration, cruising, and the like. Primarily, these discretized methods are based on the principles of minimizing unnecessary alternator operation and taking advantage of vehicle kinetic energy during deceleration. Moreover, batteries are normally kept in a charging state, regardless of efficiency and state of charge.

These approaches focus on the efficiency of individual subsystems, and do not consider the efficiency of the overall system; that is, the relationship between the engine, alternator and battery. A new approach that maximizes overall system efficiency and examines both electrical energy generation, storage and engine operation to improve fuel economy is therefore warranted.

### SUMMARY

In various example embodiments, the present disclosure provides methods and apparatus for improving vehicle fuel economy using an energy storage efficiency model. Broadly, the disclosure proposes a management strategy to control electrical energy generation and consumption in a vehicle so as to improve fuel economy. When the vehicle is operating under conditions that electrical energy can be produced and stored efficiently, the generator will be fully engaged, even if demand is not high. The excess electrical energy is stored for later consumption. An efficiency model takes into consideration engine efficiency, generator efficiency, and energy storage efficiency. To fully take advantage of high efficiency conditions and ensure smooth operation of the vehicle, the level of state of charge of electrical energy storage is constantly monitored and carefully controlled.

The efficiency model used herein is based on the operational efficiencies of the generator (typically an alternator), energy storage medium (typically a battery), and engine, within the constraint of maintaining a minimum required state of charge in the energy storage medium. Both the generator and energy storage medium have their own “most efficient” operating conditions. For instance, turning the generator on and off effectively changes the engine operating point, thus altering engine operation efficiency. Vehicle fuel economy ultimately depends on the overall system efficiency, not directly on its individual subsystem efficiencies.

One such embodiment includes a method for improving fuel economy in a vehicle having an engine, a generator driven by the engine, and an energy storage unit by using an energy storage efficiency model. The method includes evaluating a current efficiency state of the engine, evaluating a current efficiency state of the generator, and evaluating a current efficiency state of the energy storage unit. Based on the results of the evaluations and the energy storage efficiency model, the generator is controlled to provide an optimized voltage output. The method further includes determining whether the vehicle is decelerating, and if so, maximizing voltage output so as to accumulate maximum charge in the energy storage unit. A voltage regulator implementing this method is also described.

Evaluating the current efficiency state of the engine generally includes determining whether an increase in generator load will result in a positive or negative change in efficiency, given a current torque output of the engine. This can further include using an efficiency curve to determine whether an increase in generator load will result in a positive or negative change in efficiency. Evaluating the current efficiency state of the generator includes determining generator rotor speed and field current. Evaluating the current efficiency state of the energy storage unit includes determining a current regulator output voltage, a state of charge of the energy storage unit, and a temperature of the energy storage unit.

One exemplary energy storage efficiency model provides that voltage output will be set sufficiently high so as to accumulate charge in the energy storage unit if: a) a state of charge of the energy storage unit is below a minimum threshold, b) the efficiency state change of the engine due to the generator engagement is positive, the efficiency states of the generator and energy storage unit are high, and the state of charge of the energy storage unit is below an overcharge threshold; or c) the efficiency state change of the engine is positive, the efficiency state of the generator is high, and the state of charge of the energy storage unit is below a midpoint threshold. The efficiency model further provides that voltage output will be set sufficiently high so as to maintain a state of charge in the energy storage unit if a) the efficiency state change of the engine is positive, the efficiency states of the generator and energy storage unit are high, and the state of charge of the energy storage unit is above an overcharge threshold; or b) the efficiency state change of the engine is positive and the efficiency state of the generator is high and the efficiency state of the energy storage unit is low.

Further areas of applicability of the present disclosure will become apparent from the detailed description and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 shows a schematic of power generation and storage components in an exemplary vehicle.

FIG. 2 shows an exemplary engine efficiency curve at a given engine speed.

FIG. 3 shows a graph representation of an exemplary energy storage efficiency model.

FIG. 4 shows a flowchart representation of an exemplary energy storage efficiency model.

FIG. 5 shows relative values of the efficiency and state of charge thresholds referenced in the FIG. 4 flowchart.

### DETAILED DESCRIPTION OF THE FIGURES

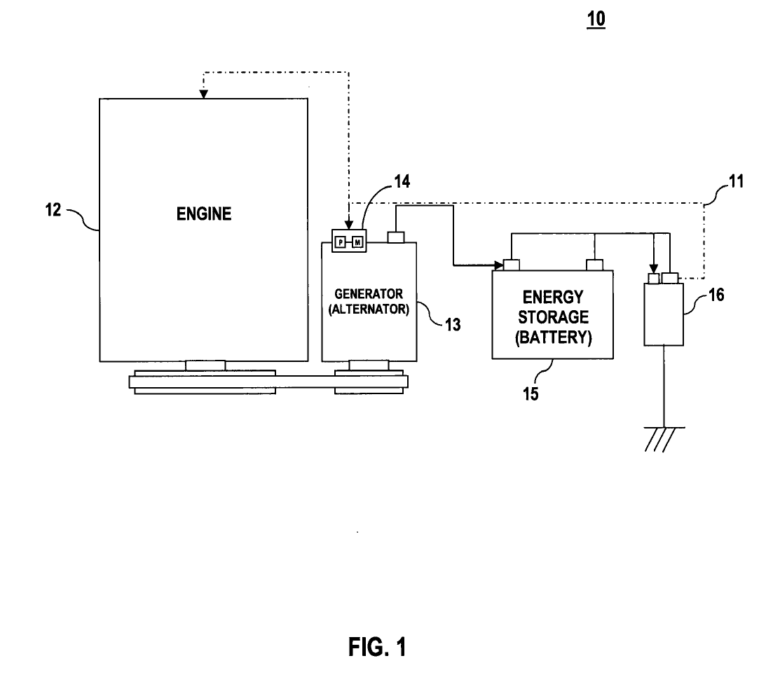

FIG. 1 illustrates power generation and storage components in an exemplary vehicle 10. Generally, vehicle 10 includes an engine 12, a generator 13, and an energy storage unit 15. Engine 12 is generally connected so as to drive generator 13 via a flywheel and belt (shown in FIG. 1 but not labeled). Typically, generator 13 is an alternator, controlled by a voltage regulator 14. An output of the generator 13 is connected to an input terminal of energy storage unit 15 (typically a battery). An energy storage monitor 16 can also be included, so as to communicate 11 information, about, for example, a state of charge (SOC) of energy storage unit 15, between the monitor 16, generator 13 and engine 12 Voltage regulator 14, which is responsible for controlling the output of generator 13, is typically configured so as to receive inputs from the engine 12, generator 13, and energy storage unit 15 (via energy storage monitor 16, if included), to a memory for evaluation by a processor.

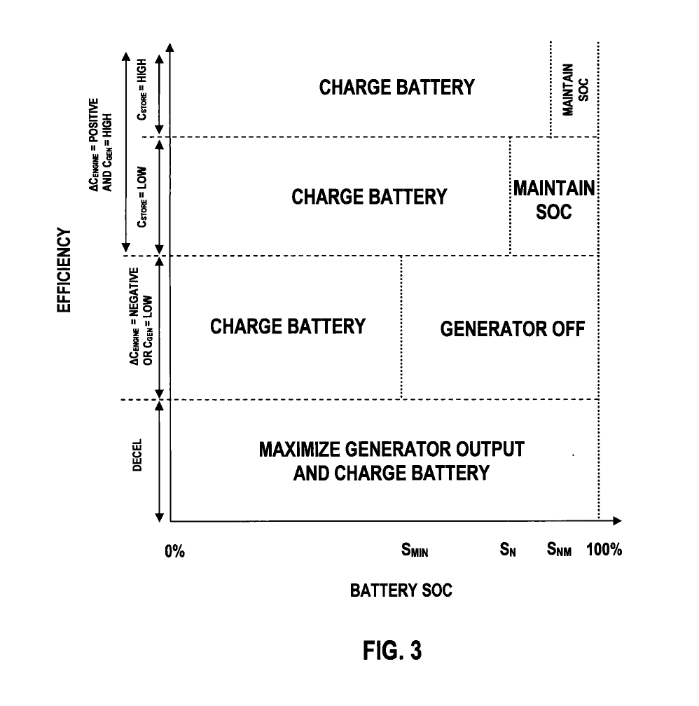

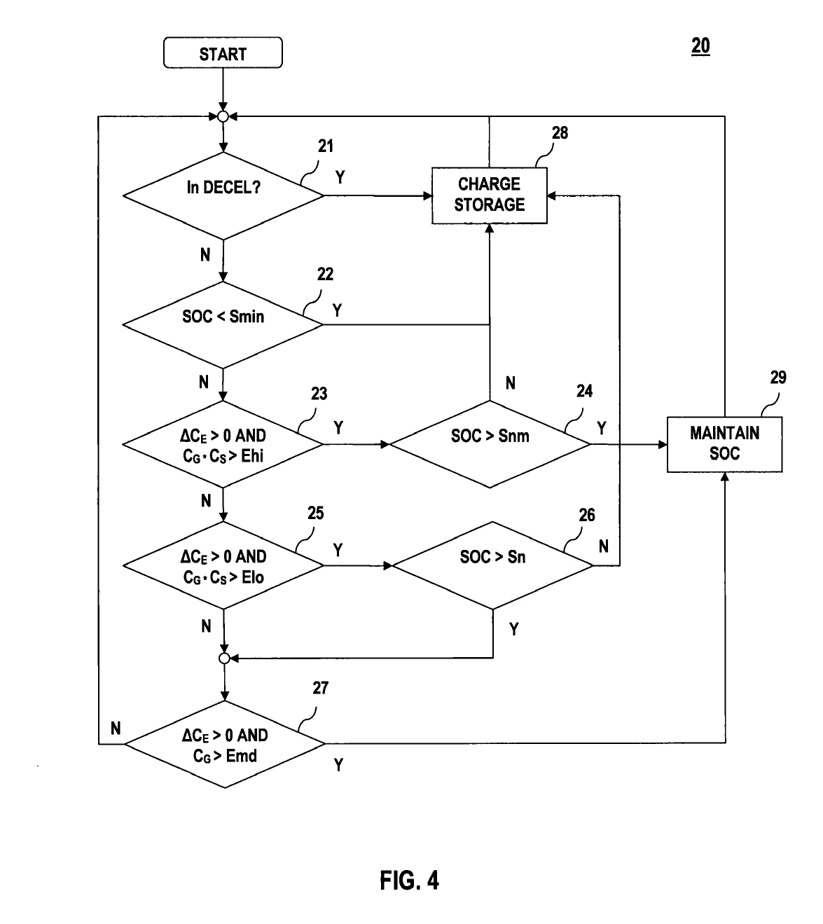

As noted above, one overall objective of the methods disclosed herein is to improve the electrical energy generation, storage and consumption efficiency of the vehicle 10. This is accomplished using an energy storage efficiency model, as will be described in more detail below with reference to FIGS. 3 and 4. The energy storage efficiency model prescribes certain actions based on evaluations of the current efficiency states of, e.g., engine 12, generator 13, and energy storage unit 15. The energy storage efficiency model can also include prescribed actions based on operating states of the vehicle.

For instance, an energy storage efficiency model can automatically maximize generator 13 output during vehicle 10 deceleration, so as to recoup kinetic energy generated by vehicle 10 as it slows. This allows energy storage unit 15 to be charged at a maximum possible level. Of course, the state of charge of the energy storage unit 15 needs to generally be maintained at less than 100% in order to store electrical energy generated during deceleration. Accordingly, during normal vehicle 10 operation, the energy storage unit 15 is maintained at a state of charge of less than 100%. Within vehicle 10, other electrical energy consumers can also be instructed to fully take advantage of this ‘free’ energy without compromising performance and functionality. For instance, a cooling fan of engine 12 might increase output RPMs during deceleration. Other examples of subsystems that can take advantage of deceleration include vehicle 10's climate control subsystem.

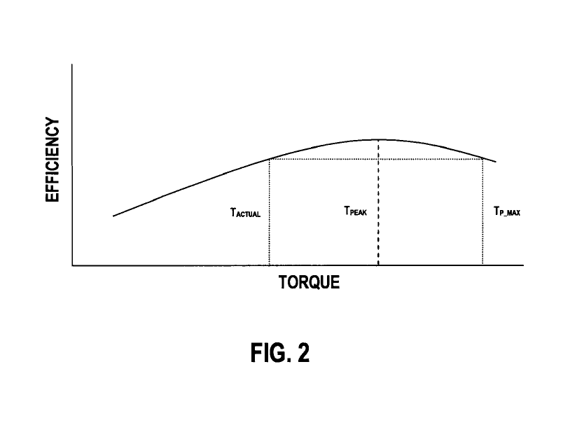

As to evaluating efficiency states of the various components of the vehicle 10, in order to evaluate the current engine 12 efficiency state, a torque efficiency curve, such as that depicted in FIG. 2, is useful. Generally, the torque required to drive generator 13 is an incremental load to engine 12 output. Engine 12 efficiency is mainly a function of its speed and output torque. At a given engine speed, varying output torque will change its efficiency. If energy storage unit state of charge permits, generator 13 engagement should be scheduled in such a way that engine 12 efficiency is being improved. Accordingly, engaging generator 13 can be based, at least in part, on whether there will be a positive or negative change to engine 12 efficiency.

As noted above, FIG. 2 depicts an exemplary efficiency curve. At a given engine speed, the engine 12 operation efficiency is a function of output torque. The efficiency curve has a peak (Tₚₑₐₖ) that is the highest efficiency at a given engine speed. If actual engine torque is larger than Tₚₑₐₖ, any torque increment will further reduce the engine 12 efficiency. If actual engine torque is less than Tₚₑₐₖ, engine 12 efficiency will improve. To simplify control strategy, Tₚₑₐₖ, which is independent of the actual output torque (T_{actual}), can be determined with a mapping process, at, e.g., a factory, or service center. Tₚₑₐₖ values at various engine speeds can be defined by a two-dimensional function. Desired additional torque due to generator 13 engagement should therefore be within the range of Tₚₑₐₖ and T_{actual}.

When the state of charge of the energy storage unit 15 is low and close enough to a critical state (Sₘᵢₙ), constraining generator 13 engagement to be within the range of Tₚₑₐₖ and T_{actual} may not allow generator 13 to generate enough output to maintain the current state of charge of energy storage unit 15. Accordingly, rather than letting the state of charge of energy storage unit 15 decrease to the critical state and then charging energy storage unit 15 unconditionally, increasing the torque increment range to twice the difference between Tₚₑₐₖ and T_{actual} permits maintaining the state of charge without much compromise of engine 12 operation efficiency. Specifically, since the efficiency curve as compared with torque at a given engine speed is generally smooth, it is reasonable to assume some symmetry of the efficiency curve around Tₚₑₐₖ, especially within a relatively small range of Tₚₑₐₖ. Accordingly, engaging generator 13 can also be based, at least in part, on whether engine 12 efficiency will be within this established range, when generator 13 is active.

In such determinations, the engine 12 efficiency change due to alternator load can be determined as a function of the current engine 12 torque, the range of Tₚₑₐₖ and T_{actual}, and the increase in torque associated with activating the generator 13.

Another component to be evaluated for efficiency is generator 13. The efficiency state of generator 13 is primarily a function of rotor speed and field current. The rotor speed generally has a fixed ratio over the engine speed and the field current is proportional to the output duty cycle rate. The field current directly determines the additional torque applied to the engine and is a function of generator 13's target output voltage, energy storage unit 15's open circuit voltage, total electrical load, and state of charge. Lowering generator 13's target output voltage without changing energy storage unit 15's open circuit voltage, total electrical load, and state of charge does not result in a significant torque reduction.

Energy storage unit 15 should also be evaluated for its efficiency state, which is generally a function of generator 13's output voltage, energy storage unit 15's state of charge, and energy storage unit 15's temperature.

FIG. 3 illustrates an exemplary energy storage efficiency model based on the above evaluations of the efficiency states of engine 12, generator 13 and energy storage unit 15. As can be seen in the model, actions to be taken are based on evaluations of the current efficiency states. First, if the vehicle 10 is decelerating, generator 13 output is maximized and energy storage unit 15 is charged regardless of its current state of charge. If the engine 12 efficiency state change as evaluated will be negative, or the current generator 13 efficiency state is low, energy storage unit 15 will only be charged if its state of charge is below a critical state (Sₘᵢₙ). Otherwise, generator 13 will be deactivated. If the engine 12 efficiency state change as evaluated is positive, and the efficiency state of the generator 13 is high, then energy storage unit 15 will be charged above critical state (Sₘᵢₙ) to a point determined by the efficiency state of energy storage unit 15. If the efficiency state of the energy storage unit 15 is low, then charging will only occur to a midpoint threshold. If the efficiency state of the energy storage unit 15 is high, then charging will occur until an overcharge (high) threshold.

FIG. 4 illustrates the FIG. 3 energy storage efficiency model as a process 20 that might be implemented by voltage regulator 14. At step 21, voltage regulator 14 determines whether vehicle 10 is decelerating. If so, at step 28, energy storage unit 15 is charged regardless of the current state of charge. If not decelerating, the state of charge (SOC) of energy storage unit 15 is examined, at step 22. If the state of charge of energy storage unit 15 is less than a critical state (Sₘᵢₙ), energy storage unit 15 is charged. If the current state of charge is not less than the critical state (Sₘᵢₙ), at step 23, the efficiency states of engine 12, generator 13 and energy storage unit 15 are evaluated. If the engine 12 efficiency state change (ΔC_{ENGINE} or ΔC_{E}) is positive, and the efficiency states of generator 13 and energy storage unit 15 are together (C_{G}*Cₛ) higher than a relative highpoint threshold (Ehi), the state of charge of energy storage unit 15 is examined at step 24. If the state of charge of energy storage unit 15 is above an overcharge threshold (Sₙₘ), the state of charge of energy storage unit 15 is maintained at step 29. If the SOC is not above Sₙₘ, energy storage unit 15 is charged. At step 25, if the engine 12 efficiency state change (ΔC_{E}) is positive, and the efficiency states of generator 13 and energy storage unit 15 are together (C_{G}*Cₛ) higher than a relative lowpoint threshold (Elo), the state of charge of energy storage unit 15 is examined at step 26. If the state of charge of energy storage unit 15 is below a charge median threshold (Sₙ), energy storage unit 15 is charged at step 28. If the SOC is above Sₙ, the state of charge of energy storage unit 15 is maintained at step 29 only if the efficiency state of the generator 13 (C_{G}) is above a midpoint threshold (Emd) (step 27).

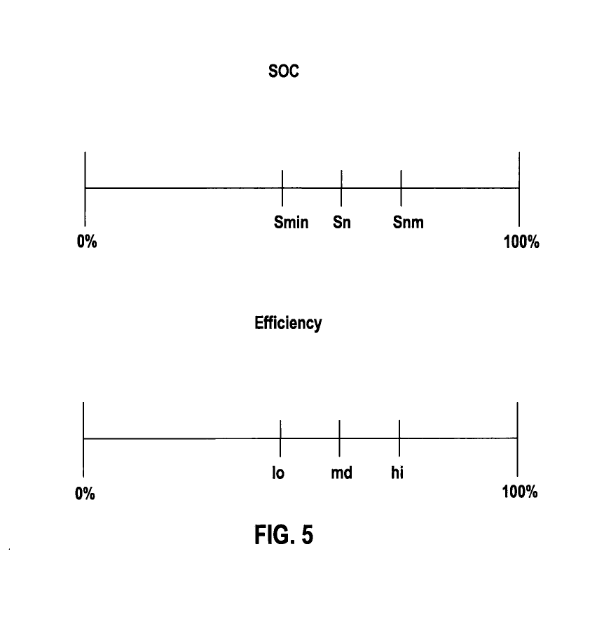

FIG. 5 shows the relative values of the efficiency and state of charge thresholds. Of course, it should be understood that the actual values of the efficiency and state of charge thresholds can be set by an evaluation of each component (engine 12, generator 13 and energy storage unit 15) of the vehicle 10, i.e., at a factory or a service center when service is performed. These thresholds can be stored (and subsequently updated) in a memory of the voltage regulator 14.

What is claimed is:

1. A method of improving fuel economy in a vehicle comprising an engine, a generator driven by the engine, and an energy storage unit by using an energy storage efficiency model, the method comprising:
evaluating a current efficiency state of the engine;
evaluating a current efficiency state of the generator;
evaluating a current efficiency state of the energy storage unit; and
controlling the generator to provide an optimized voltage output, based on the results of the evaluations and the energy storage efficiency model.

2. The method of claim 1, further comprising determining whether the vehicle is decelerating and, if so, maximizing voltage output so as to accumulate maximum charge in the energy storage unit.

3. The method of claim 1, wherein evaluating the current efficiency state of the engine comprises determining whether an increase in generator load will result in a positive or negative change in efficiency, given a current torque output of the engine.

4. The method of claim 3, wherein evaluating the current efficiency state of the engine further comprises using an efficiency curve to determine whether an increase in generator load will result in a positive or negative change in efficiency.

5. The method of claim 3, wherein evaluating the current efficiency state of the generator comprises determining generator rotor speed and field current.

6. The method of claim 3, wherein evaluating the current efficiency state of the energy storage unit comprises determining a current regulator output voltage, a state of charge of the energy storage unit, and a temperature of the energy storage unit.

7. The method of claim 3, wherein the energy storage efficiency model indicates that voltage output will be set sufficiently high so as to accumulate charge in the energy storage unit if:
a) a state of charge of the energy storage unit is below a minimum threshold;
b) the efficiency state of the engine is positive, the efficiency states of the generator and energy storage unit are high, and the state of charge of the energy storage unit is below an overcharge threshold; or
c) the efficiency state change of the engine is positive, the efficiency state of the generator is high, and the state of charge of the energy storage unit is below a midpoint threshold.

8. The method of claim 6, wherein the energy storage efficiency model indicates that voltage output will be set sufficiently high so as to maintain a state of charge in the energy storage unit if:
a) the efficiency state change of the engine is positive, the efficiency states of the generator and energy storage unit are high, and the state of charge of the energy storage unit is above an overcharge threshold; or
b) the efficiency state change of the engine is positive and the efficiency state of the generator is low.

9. The method of claim 8, wherein the energy storage efficiency model indicates that the generator should be deactivated if the efficiency state change of the engine is negative or the efficiency state of the generator is low, and the state of charge of the energy storage unit is above the minimum threshold.

10. A voltage regulator comprising:
a processor and connected memory; the processor being adapted to:
evaluate a current efficiency state of a connected engine;
evaluate a current efficiency state of a connected generator;
evaluate a current efficiency state of a connected energy storage unit; and
based on the results of the evaluations and an energy storage efficiency model, control the connected generator to provide an optimized voltage output.

11. The voltage regulator of claim 10, wherein the connected generator is an alternator.

12. The voltage regulator of claim 10, wherein the connected energy storage unit is a battery.

13. The voltage regulator of claim 10, wherein evaluating the current efficiency state of a connected engine comprises determining an efficiency curve of the connected engine.

14. The voltage regulator of claim 13, wherein the efficiency curve establishes a range in which an increase in engine torque does not decrease overall efficiency of the engine.

15. The voltage regulator of claim 10, wherein the energy storage efficiency model indicates that voltage output will be set sufficiently high so as to accumulate charge in the energy storage unit if:
a) a state of charge of the energy storage unit is below a minimum threshold;
b) the efficiency state change of the engine is positive, the efficiency states of the generator and energy storage unit are high, and the state of charge of the energy storage unit is below an overcharge threshold; or
c) the efficiency state change of the engine is positive, the efficiency state of the generator is high, and the state of charge of the energy storage unit is below a midpoint threshold.

16. The voltage regulator of claim 15, wherein the energy storage efficiency model indicates that voltage output will be set sufficiently high so as to maintain a state of charge in the energy storage unit if:
a) the efficiency state change of the engine is positive, the efficiency states of the generator and energy storage unit are high, and the state of charge of the energy storage unit is above an overcharge threshold; or
b) the efficiency state change of the engine is positive and the efficiency state of the generator is low.

17. The voltage regulator of claim 16, wherein the energy storage efficiency model indicates that the generator should be deactivated if the efficiency state change of the engine is negative or the efficiency state of the generator is low, and the state of charge of the energy storage unit is above the minimum threshold.
